(19) United States
(12) Patent Application Publication
(10) Pub. No.: US 2008/0103941 A1
(43) Pub. Date: May 1, 2008

(54) Methods, systems, and products for managing inventory

(76) Inventor: Altaf Hussain, Alpharetta, GA (US)

Correspondence Address: SCOTT P. ZIMMERMAN, PLLC, PO BOX 3822, CARY, NC, 27519, US

(21) Appl. No.: 11/588,797

(22) Filed: Oct. 27, 2006

(51) Int. Cl. G06Q 10/00

(52) U.S. Cl. 705/28

(57) ABSTRACT

Methods, systems, and products are disclosed for managing inventory. A layout of a building is accessed that includes the number of rooms in the building and a description of each of each of the rooms. Article information is received that describes an article to be inventoried. The article information is associated to a room descriptor that describes a room in the building and the article information is stored in memory.

### CROSS-REFERENCE TO RELATED APPLICATIONS

This application relates to the commonly-assigned and concurrently filed U.S. application Ser. No. ______ (Attorney Docket BS060254), entitled “Intelligent Inventory Applications and Services,” and incorporated herein by reference in its entirety.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

The exemplary embodiments generally relate to data processing and, more particularly, to inventory monitoring and management.

Inventory monitoring and management needs improvement. Conventional inventory systems track the quantity of an item and, when that item needs replenishment, issue orders for that item. These conventional inventory systems, however, do not organize the inventory on a room-by-room basis. That is, conventional inventory systems only inventory a person's property and possessions—the conventional inventory systems do not organize the inventory according to each room in a building. Moreover, conventional inventory systems provide no assistance when purchasing items. Even though an item is inventoried, a person may still purchase a duplicate item. Conventional inventory systems do not alert a person when a duplicate item, already in the inventory, is about to be purchased. Conventional inventory systems, then, lack intelligence to help us make informed purchasing decisions for the products we need. What is needed, then, are methods, systems, and products for managing inventory that have greater intelligence than conventional systems.

### SUMMARY

The exemplary embodiments provide methods, systems, and products for managing inventory. These exemplary embodiments describe an intelligent inventory system that organizes and inventories a user's property and possessions on a room-by-room basis. This intelligent inventory system uses a business, warehouse, or residential building layout to organize the inventory according to each room in the building. The layout describes the building or home and how many rooms are in the facility. Each area or room may also be associated with a unique descriptor (e.g., “pen #1,” “dock #10,” “living room,” and/or “basement”), thus allowing exemplary embodiments to uniquely inventory each area. Exemplary embodiments also permit each occupant of the building to uniquely configure “their” inventoried space. That is, if a room is associated with one or more persons, those persons may configure how their space is inventoried. A manager, for example, may configured the inventoried items in her office as “public” or “private,” thus permitting, or prohibiting, access to those items. A user may even set permissions, thus identifying those people who may access the user's inventory of items. As later paragraphs will explain, the layout may even describe the electrical and communications outlets installed within any room or area. Exemplary embodiments may thus note or flag inventoried items that are incompatible with the electrical outlets or the communications outlets installed in the room. Exemplary embodiments may even store that complete inventory on any computer-readable media, such as a magnetically-encoded card, for easy access and update.

Exemplary embodiments include a method for managing inventory. A layout of a building is accessed that includes the number of rooms in the building and a description of each of the rooms. Article information is received that describes an article to be inventoried. The article information is associated to a room descriptor that describes a room in the building and the article information is stored in memory.

More exemplary embodiments include a system for managing inventory. An inventory management application is stored in memory, and a processor communicates with the memory and executes the inventory management application. The inventory management application instructs the processor to access a layout of a building that describes a number of rooms in the building and a description of each of the rooms. Article information is received that describes an article to be inventoried. The article information is associated to a room descriptor that describes a room in the building and the article information is stored in memory.

Other exemplary embodiments describe a computer program product for managing inventory. A layout of a building is accessed that includes the number of rooms in the building and a description of each of the rooms. Article information is received that describes an article to be inventoried. The article information is associated to a room descriptor that describes a room in the building and the article information is stored in memory.

Other systems, methods, and/or computer program products according to the exemplary embodiments will be or become apparent to one with ordinary skill in the art upon review of the following drawings and detailed description. It is intended that all such additional systems, methods, and/or computer program products be included within this description, be within the scope of the claims, and be protected by the accompanying claims.

### BRIEF DESCRIPTION OF THE SEVERAL VIEWS OF THE DRAWINGS

These and other features, aspects, and advantages of the exemplary embodiments are better understood when the following Detailed Description is read with reference to the accompanying drawings, wherein:

FIG. 1 is a schematic illustrating a network environment in which exemplary embodiments may be implemented;

FIG. 2 is a schematic illustrating communications outlet information, according to more exemplary embodiments;

FIG. 3 is a schematic illustrating communications equipment information, according to even more exemplary embodiments;

FIG. 4 is a schematic illustrating electrical comparisons, according to still more exemplary embodiments;

FIG. 5 is a schematic illustrating material associations, according to more exemplary embodiments;

FIGS. 6-8 are schematics illustrating a process for remote accessibility, according to even more exemplary embodiments;

FIG. 9 is a schematic illustrating an inventory database, according to still more exemplary embodiments; and

FIG. 10 depicts other possible operating environments for additional aspects of the exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items. It will also be understood that the terms “article” or “articles,” when used in this specification, include the presence of any physical or logical material or materials, but do not preclude any presence of any object or objects which may be of some use.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

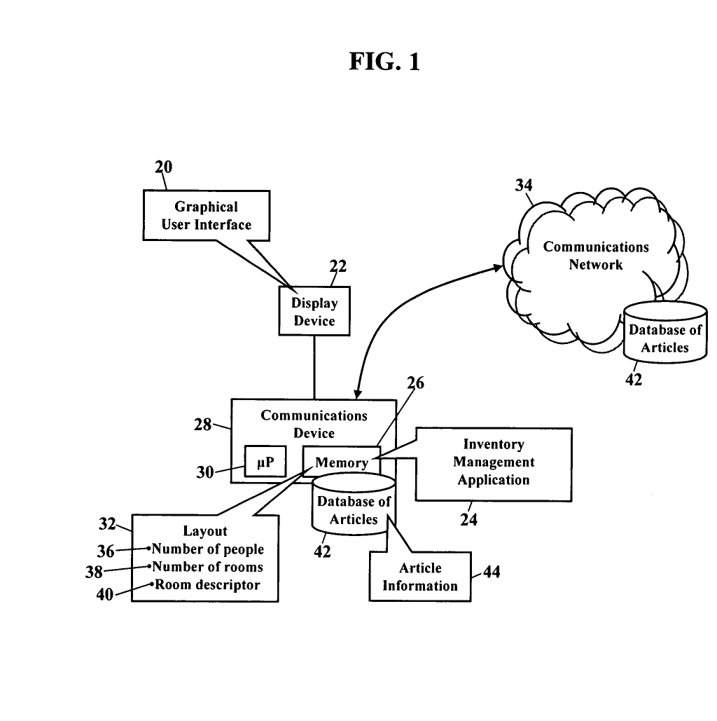

FIG. 1 is a schematic illustrating an environment in which exemplary embodiments may be implemented. A graphical user interface 20 is visually presented on a display device 22 by an inventory management application 24. The inventory management application 24 is a set of processor-executable instructions that create and maintain an inventory of articles for a business or residence (hereinafter the “user”). The inventory management application 24 is stored in memory 26 of a communications device 28. Although the communications device 28 is generically shown, the communications device 28, as will be later explained, may be a computer, a personal digital assistant (PDA), a cordless/cellular/IP phone, or any other processor-controlled device. Whatever the communications device 28, the communications device 28 has a processor 30 (e.g., “μP”), application specific integrated circuit (ASIC), or other similar device that executes the inventory management application 24. The inventory management application 24 is a software engine that tracks an inventory of the user's property and possessions. Anything the user purchases, owns, and/or possesses, such as vehicles, supplies, chattel, furniture, jewelry, and food, is logged and tracked by the inventory management application 24. The inventory management application 24 may even log and/or track possession of borrowed items, such as tools, videos, books, or DVDs that the user borrowed from a friend or neighbor. The inventory management application 24 may even log and/or track another person's possession of loaned items, such as tools that the user loaned to a neighbor. The inventory management application 24 may even log and/or track the user's ownership and/or possession of real property. The user may utilize any user interface (such as a keyboard, tactile “mouse” or other device, and/or graphical user interface) to manually enter her/his property and possessions into the inventory management application 24. As later paragraphs will explain, however, the inventory management application 24 may even interface with a manufacturer's or retailer's computer system to automatically download or obtain information regarding purchases and then inventory those purchases. Whatever items or parcels the user owns or possesses or dispossesses, the inventory management application 24 maintains an up-to-date inventory of those articles. Exemplary embodiments thus describe an intelligent inventory system that organizes and inventories a user's property and possessions on a room-by-room basis.

According to exemplary embodiments, the inventory management application 24 accesses a building layout 32. The building layout 32 is a computer-readable file that describes the user's business, premises, warehouse, or residence. The layout 32 may be locally stored in the memory 26 of the communications device 28, or the layout 32 may be remotely accessible via a communications network 34. However the layout 32 is accessed, the layout 32 describes how many people 36 occupy the building and how many rooms 38 are in the building. Each room may also be associated with a room descriptor 40 (e.g., “atrium,” “conference room,” “living room,” “bedroom,” “garage,” and/or “basement”). Because each room preferably is associated with a unique room descriptor, the inventory management application 24 may uniquely inventory each room in the building.

The inventory management application 24 also accesses a database 42 of articles. The database 42 of articles stores and maintains a listing of each article owned and/or possessed by the user. The database 42 of articles may be locally stored in the memory 26 of the communications device 28, or the database 42 of articles may be remotely accessible via the communications network 34. The database 42 of articles stores article information 44 that describes each article owned and/or possessed by the user. The article information 44 may include a description of each or any article in the database 42 of articles, such as a manufacturer and/or seller, model number, color(s), material(s), component(s), and distribution/delivery chain. The article information 44 may also describe whether the article is owned by the user, borrowed by or from the user, or on loan from another. The article information 44 may also describe the particular room in the building where the article is or should be located. When the inventory management application 24 receives the article information 44, the inventory management application 24 instructs the processor 30 to associate the article information 44 to a room descriptor 40. That is, the inventory management application 24 maintains an inventory of the user's articles on a room-by-room basis. Here, then, exemplary embodiments provide an inventory of each room in the building. The user not only knows what is owned and possessed, but the user knows in what room an article is (or should be) located. The inventory management application 24 thus provides a more meaningful, helpful, and accurate inventory of the user's personal property and real property.

The communications device 28 is only simply illustrated. Because the architecture and operating principle of the communications device 28 is well known, the hardware and software components of the communications device 28 are not further shown and described. If the reader desires more details, the reader is invited to consult the following sources, all incorporated herein by reference in their entirety: ANDREW TANENBAUM, COMPUTER NETWORKS (4^{th} edition 2003); WILLIAM STALLINGS, COMPUTER ORGANIZATION AND ARCHITECTURE: DESIGNING FOR PERFORMANCE (7^{th} Ed., 2005); and DAVID A. PATTERSON & JOHN L. HENNESSY, COMPUTER ORGANIZATION AND DESIGN: THE HARDWARE/SOFTWARE INTERFACE (3^{rd}. Edition 2004).

Some aspects of inventory management are known, so this disclosure will not greatly explain the known details. If the reader desires more details, the reader is invited to consult the following sources, all incorporated herein by reference in their entirety: U.S. Pat. No. 6,204,763 to Sone (Mar. 20, 2001); U.S. Pat. No. 6,430,541 to Brown et al. (Aug. 6, 2002); U.S. Pat. No. 6,988,080 to Zack et al. (Jan. 17, 2006); U.S. Pat. No. 7,065,501 to Brown et al. (Jun. 20, 2006); Published U.S. Patent Application 2002/0049652 to Moore et al. (Apr. 25, 2002); Published U.S. Patent Application 2003/0214387 to Giaccherini (Nov. 20, 2003); Published U.S. Patent Application 2006/0157564 to Schulte (Jul. 20, 2006); Published U.S. Patent Application 2006/0190273 to Wilbrink et al. (Aug. 24, 2006); and Published U.S. Patent Application 2006/0190363 to Brown et al. (Aug. 24, 2006).

Exemplary embodiments may also be applied regardless of networking environment. The communications network 34 may be a cable network operating in the radio-frequency domain and/or the Internet Protocol (IP) domain. The communications network 34, however, may also include a distributed computing network, such as the Internet (sometimes alternatively known as the “World Wide Web”), an intranet, a local-area network (LAN), and/or a wide-area network (WAN). The communications network 34 may include coaxial cables, copper wires, fiber optic lines, and/or hybrid-coaxial lines. The communications network 34 may even include wireless portions utilizing any portion of the electromagnetic spectrum and any signaling standard (such as the I.E.E.E. 802 family of standards, GSM/CDMA/TDMA or any cellular standard, and/or the ISM band). The concepts described herein may be applied to any wireless/wireline communications network, regardless of physical componentry, physical configuration, or communications standard(s).

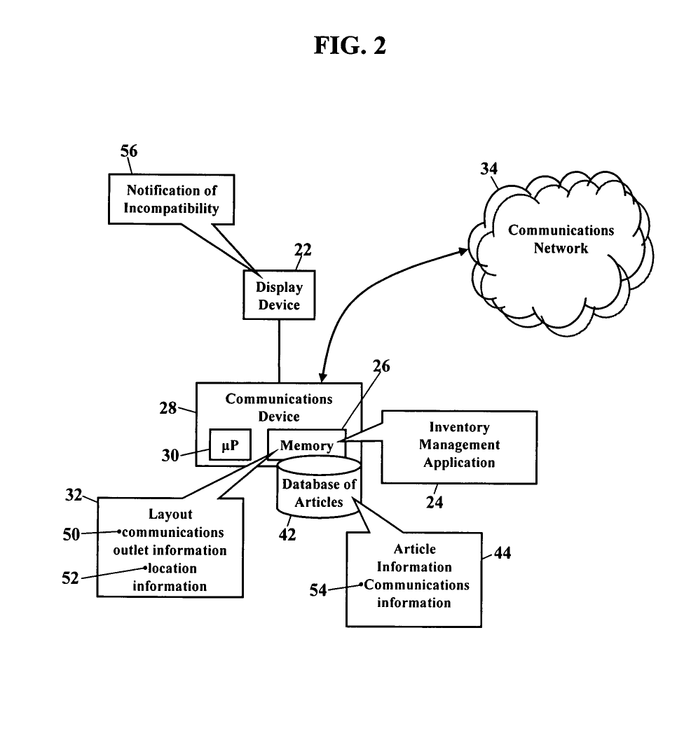

FIG. 2 is a schematic illustrating communications outlet information 50, according to more exemplary embodiments. Here, when the inventory management application 24 accesses the residential or business layout 32, the layout 32 may include the communications outlet information 50. This communications outlet information 50 may describe one or more communications outlets installed within any room of the building. The communications outlet information 50 may describe any male or female outlets installed in the building and/or within any room in the building. The communications outlet information 50, for example, may describe cable jacks, RJ-11 jacks, RJ-12 jacks, RJ-45 jacks, and even electrical outlets (such as two-prong and three-pong) for communications via powerline transmission. Any outlets or jacks that may be used for communications purposes may be described by the communications outlet information 50.

The communications outlet information 50 may include location information 52. The location information 52 is any information that helps describe a location of each communications outlet within the building and/or within a room. The location information 52, for example, may describe the room in which the outlet is installed. The location information 52 may even describe a wall in which the outlet is installed (such as “north wall,” or “closet wall,” or “exterior wall”). The location information 52 may even include dimensional location information, such as a length and/or angle measurement from a distinguishing feature or reference location (e.g., “4 feet along a 35 degree line from the southwest corner of the westerly wall in Billy's room”). The location information 52 thus identifies a location of any communications outlet within the building and/or within a room.

The inventory management application 24 again accesses the database 42 of articles. The database 42 of articles stores and maintains a listing of each article owned and/or possessed by the user. Here, however, the database 42 of articles may also store communications information 54 describing the communications requirements of any article to be inventoried. The communications information 54 may describe an article's communications outlet or port requirements. A television, for example, may include a female RJ-45 input jack to receive Internet Protocol television packets. The television may additionally or alternatively include a female coaxial cable input jack to receive signals via a coaxial cable. When the inventory management application 24 receives the article information 44, the article information 44 may also include the communications information 54 describing the communications requirements of the article to be inventoried. The inventory management application 24 instructs the processor 30 to associate the article information 44, including the communications information 54, to the communications outlet information 50.

The inventory management application 24 may even make intelligent comparisons. As the inventory management application 24 inventories the user's articles on a room-by-room basis, the inventory management application 24 may compare an article's communications information 54 to its associated communications outlet information 50. That is, the inventory management application 24 may compare an article's communications outlet or port requirements (described by the article's communications information 54) to the communications outlet information 50. Because the communications outlet information 50 may describe a communications outlet installed within a room of the building, and that outlet's location (using the location information 52), the inventory management application 24 may intelligently spot incompatibilities in the layout 32. Suppose a television's communications information 54 describes how a required female coaxial cable input jack is required to receive cable signals. If the communications outlet information 50 does not describe a coaxial cable outlet in the room associated with the television, then the inventory management application 24 may flag a communications incompatibility problem. The inventory management application 24, for example, may instruct the processor 30 to audibly and/or visually produce a prompt 56 on the display device 22. The prompt 56 notifies the user of the incompatibility.

The inventory management application 24 may compare distances. As the user's articles are inventoried, the inventory management application 24 may compare the location information 52 to an article's communications information 54. Because the location information 52 describes a location of a communications outlet, the inventory management application 24 may compare a location of an article within the room or building to the location of communications outlets. The inventory management application 24 may even determine when a distance between an outlet and the article is too great. Suppose, for example, that a television's communications information 54 describes a 3-foot CAT-5 communications cable. The television's article information 44 may also indicate that the television is associated with a bedroom in the home. The location information 52, however, may indicate that the nearest communications outlet is over ten (10) feet from the television. The television's CAT-5 communications cable, therefore, is too short to reach the nearest communications outlet. The inventory management application 24 may, therefore, flag this incompatibility problem by producing the prompt 56 on the display device 22. The inventory management application 24 may thus help the user rectify the problem at hand (such as the placement of equipment) by alerting the user to ensure an appropriate length of cable is obtained.

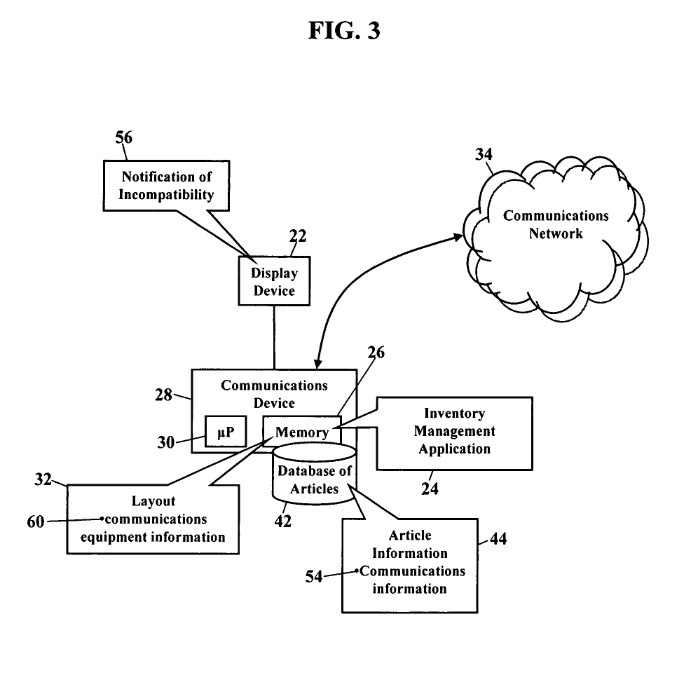

FIG. 3 is a schematic illustrating communications equipment information 60, according to even more exemplary embodiments. Here, when the inventory management application 24 accesses the layout 32, the layout 32 may include the communications equipment information 60. This communications equipment information 60 may describe any communications equipment or components operating in the building or within a room of the building. The communications equipment information 60, for example, may describe a modem, phone, computer, router, server, transceiver, or any other communications device or communications component. The communications equipment information 60 may describe a wireless transceiver (such as a WI-FI® transceiver and/or a BLUETOOTH® transceiver) operating within a room or within the building. The communications equipment information 60 may even describe the location of the communications equipment (such as “home office” or “exterior wall of second story bedroom” or by using GPS coordinates).

The database 42 of articles associates the article information 44 to the communications equipment information 60. When the inventory management application 24 accesses the database 42 of articles, the inventory management application 24 may compare the communications equipment or components operating in the building to the article information 44. The inventory management application 24 may thus determine whether the communications equipment/components operating in the room and/or building are compatible with the needs or requirements of the article to be inventoried. Suppose, for example, that the article to be inventoried is a digital movie player that requires a BLUETOOTH® connection to a computer (e.g., Apple's iTV player). The digital movie player's article information 44 would describe this BLUETOOTH® requirement. If, however, the communications equipment information 60 indicates that no BLUETOOTH® transceiver operates in the building, the inventory management application 24 may flag this incompatibility problem by producing the prompt 56.

The inventory management application 24 may even estimate signal quality for wireless transmissions. Because the inventory management application 24 has access to the layout 32, the inventory management application 24 knows the interior and exterior wall locations of the building. When wireless communications capabilities are needed, the inventory management application 24 may estimate the signal quality of these wireless transmissions. Wireless signals, for example, may attenuate or degrade when walls are encountered. Some insulation materials, for example, may have metallic layers that inhibit transmission of electromagnetic waves. The inventory management application 24 may then access the residential layout 32 and estimate the propagation strength of wireless signals throughout the building. When an article to be inventoried requires wireless capability, the inventory management application 24 may compare the distance between the location of the article and the location of a wireless transceiver. The inventory management application 24 may also estimate the signal strength of that wireless transmission, considering the signal degradation that occurs through interior and/or exterior walls. If the estimated signal is too poor for the needs of the inventoried article, the inventory management application 24 may flag this incompatibility problem by producing the prompt 56 on the display device 22.

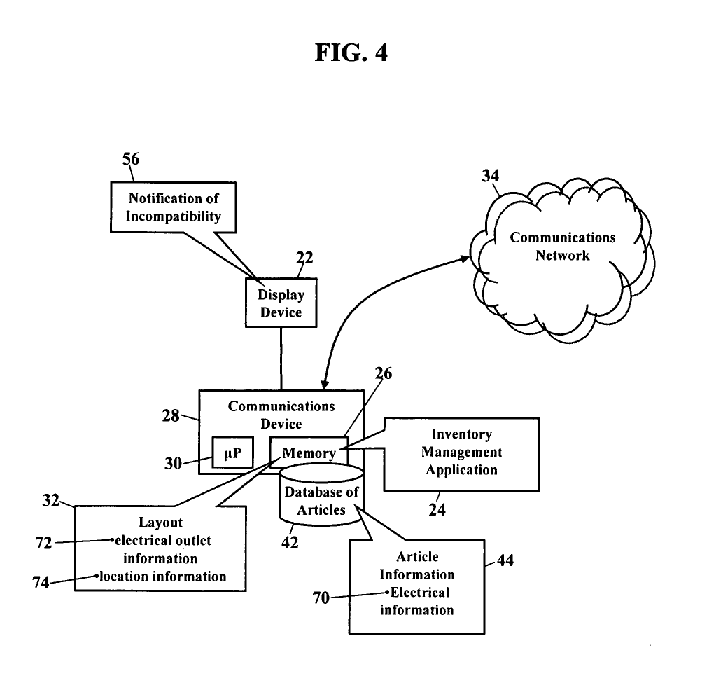

FIG. 4 is a schematic illustrating electrical comparisons, according to still more exemplary embodiments. Here, when the inventory management application 24 accesses the database 42 of articles, the database 42 of articles may include electrical information 70 for each article. Each article's electrical information 70 describes the electrical requirements of the article. The electrical information 70 may describe an article's electrical current, voltage, frequency, and/or power requirements. A television, for example, may be associated in the database 42 of articles with “120 volts, 60 Hertz, 145 maximum Watts.” The electrical information 70 may even describe a male or female plug configuration, such as a male, 3-prong, grounded plug. The electrical information 70 thus describes any electrical information or electrical requirements associated with an article to be inventoried.

The inventory management application 24 may also access electrical outlet information 72. When the inventory management application 24 retrieves the layout 32, the layout 32 may describe an electrical outlet installed within a room of the home. The electrical outlet information 72, for example, may describe whether an electrical outlet is wired for 110 volts or 220 volts. The electrical outlet information 72 may describe a male or female configuration for the outlet (such as male or female and 2-, 3-, or 4-prongs). The electrical outlet information 72 may even include location information 74 that describes a location of each electrical outlet within the building and/or within a room (similar to the location information 52 illustrated in FIG. 2).

The database 42 of articles again makes associations. The database 42 of articles associates the article information 44 and the electrical information 70 to the electrical outlet information 72. When the inventory management application 24 accesses the database 42 of articles, the inventory management application 24 may compare the electrical information 70 to the electrical outlet information 72. The inventory management application 24 may thus determine whether the electrical outlet information 72 (describing an electrical outlet installed in the room and/or home) is compatible with the electrical needs or requirements of the article to be inventoried. Suppose a new television requires a 3-prong grounded electrical outlet, but the building's older electrical outlets are ungrounded. When this electrical information 70 is incompatible with the electrical outlet information 72, the inventory management application 24 may flag this incompatibility problem by producing the prompt 56 on the display device 22. The inventory management application 24 may compare any voltage, current, frequency, or power requirement and flag incompatibilities.

The inventory management application 24 may again compare distances. The inventory management application 24 may compare the location information 74 of an electrical outlet to an article's electrical information 70. The inventory management application 24 may thus determine when a distance between an electrical outlet and the article is too great. Suppose, for example, that a television's electrical information 70 describes a 5-foot power cord. If the television's article information 44 indicates that the television is associated with a western corner of a living room, but the location information 74 indicates that the nearest electrical outlet is ten (10) feet from the television, then an incompatibility exists. The inventory management application 24 may thus flag this incompatibility problem by producing the prompt 56 on the display device 22.

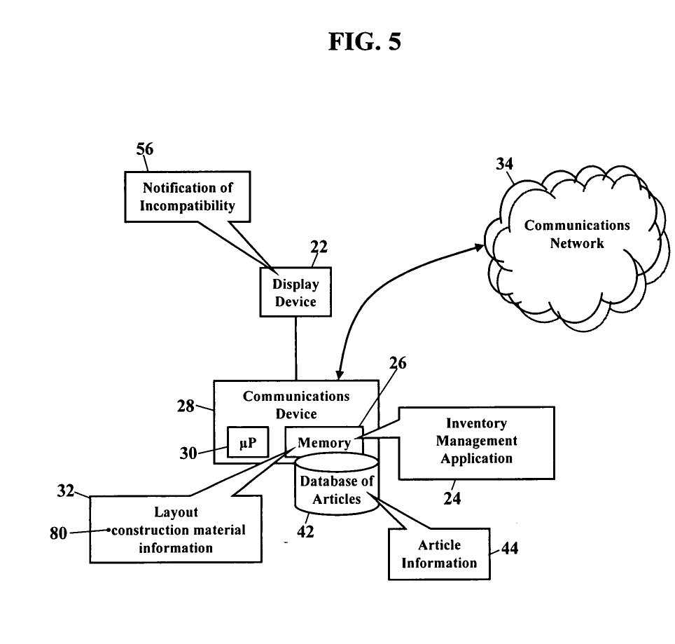

FIG. 5 is a schematic illustrating material associations, according to more exemplary embodiments. When the inventory management application 24 retrieves the residential layout 32, the residential layout 32 may describe construction material information 80. This construction material information 80 describes one or more construction materials that were used in the construction of the room or in the building. The construction material information 80, for example, may describe the building's exterior sheathing (such as brick, stone, concrete, or wood). The construction material information 80 may additionally or alternatively describe the construction and/or materials used in the building's interior walls, floor, roof, garage, and/or basement. The construction material information 80 may additionally or alternatively describe any color (including a detailed color mixture) used when painting an interior or exterior of walls, floors, and/or trim of any building, room, area, or component. The database 42 of articles associates the article information 44 to the construction material information 80. The inventory management application 24 may thus use the construction material information 80 when estimating signal strength and/or propagation paths, as earlier explained.

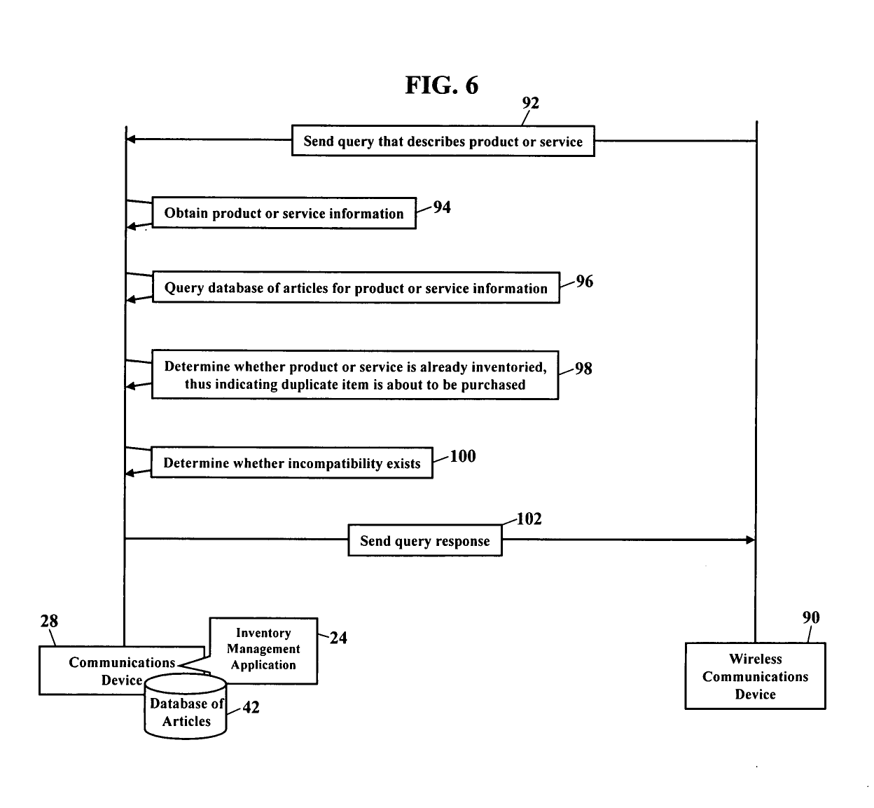

FIGS. 6-8 are schematics illustrating a process for remote accessibility to the inventory management application 24, according to even more exemplary embodiments. Here the inventory management application 24 may be remotely accessed to help make purchasing decisions. Because the communications device 28 communicates with the communications network (shown as reference numeral 34 in FIGS. 1-5), the inventory management application 24 may be remotely queried for inventory information. As the user shops for goods and services, the user may consult the inventory management application 24. The inventory management application 24 may inform the user when duplicate articles are about to be purchased or when incompatibilities may arise. The inventory management application 24 may thus assist the user in making intelligent purchasing decisions.

FIG. 6 illustrates this process. Suppose the user has a wireless communications device 90. The wireless communications device 90 may access the communications device 28, and thus the inventory management application 24, via the communications network (shown as reference numeral 34 in FIGS. 1-5). As the user shops, the user may send a query to the inventory management application 24 (Step 92). The query includes information that describes a product or service. The user, for example, may scan a bar code at the retailer that describes the product or service. The user may additionally or alternatively enter a number that uniquely identifies the product or service. Regardless, when the inventory management application 24 receives the query, the inventory management application 24 obtains the product or service information (Step 94). The inventory management application 24 then queries the database 42 of articles for the product or service information (Step 96). The database 42 of articles may determine whether the product or service is already inventoried, thus indicating a duplicate item is about to be purchased (Step 98). The database 42 of articles may also determine whether an incompatibility exists (Step 100). The inventory management application 24 then sends a query response to the user's wireless communications device 90 (Step 102). The query response includes information that indicates whether a duplicate item is about to be purchased and/or whether an incompatibility exists. The user may thus decide whether to continue purchasing the product or service.

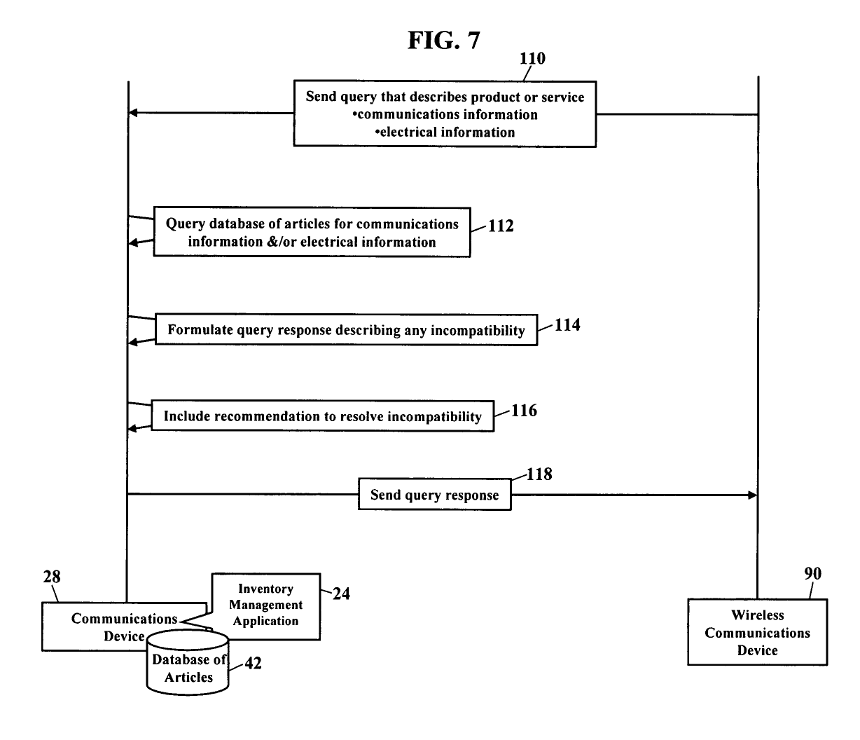

FIG. 7 illustrates the notification of incompatibilities. FIG. 7 also illustrates that the inventory management application 24 may even make recommendations to resolve the incompatibilities. Suppose, for example, that the user contemplates the purchase of a new television. The user queries the inventory management application 24 with the television's communications information 54, the television's electrical information 70, and/or any other information that describes the television (perhaps obtained from the retailer or the manufacturer or a website) (Step 110). The inventory management application 24 then queries the database 42 of articles (Step 112). If the television's communications information 54 describes a required S-video input, but neither the communications outlet information (shown as reference numeral 50 in FIG. 2) nor the communications equipment information (shown as reference numeral 60 in FIG. 3) indicate this S-video capability, then the inventory management application 24 notes this incompatibility. The inventory management application 24 formulates the query response, and the query response describes this incompatibility (Step 114). The inventory management application 24 may even include a recommendation to resolve the incompatibility (Step 116). The inventory management application 24, for example, may scan or review the television's communications information 54 and recommend an adapter or cord that could interface with the television's S-video input and be compatible with the home's existing outlets or communications equipment. The inventory management application 24 then sends the query response to the user's wireless communications device 90 (Step 118).

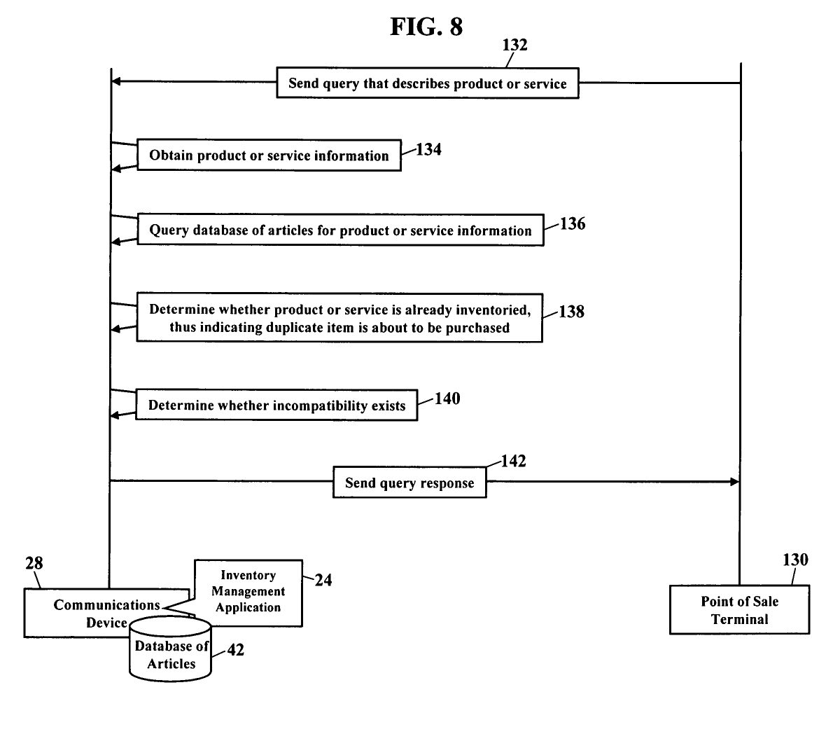

FIG. 8 illustrates point-of-sale access to the inventory management application 24. Here a point-of-sale (POS) terminal 130 may remotely access the inventory management application 24 via the communications network (shown as reference numeral 34 in FIGS. 1-5).

FIG. 8 illustrates that when the user checks out or otherwise makes their final purchases, the retailer's (or any other entity) the point-of-sale terminal 130 may query the inventory management application 24 for inventory information. Here, then, the retailer may consult the inventory management application 24 on behalf of the purchasing user. The retailer thus informs the user when duplicate articles are being purchased or when incompatibilities arise. The retailer thus utilizes the exemplary embodiments to not only assist the user in making intelligent purchasing decisions, but, also, to promote customer service and loyalty.

Because FIG. 8 is similar to FIGS. 6 and 7, FIG. 8 is only briefly discussed. As the user checks out, the point-of-sale terminal 130 sends a query to the inventory management application 24 (Step 132). The query describes a product or service being purchased, or about to be purchased, by the user. When the inventory management application 24 receives the query, the inventory management application 24 obtains the product or service information (Step 134) and queries the database 42 of articles (Step 136). The database 42 of articles determines whether the product or service is already inventoried, thus indicating a duplicate item is about to be purchased (Step 138). The database 42 of articles also determines whether an incompatibility exists (Step 140). The inventory management application 24 then sends a query response to the point-of-sale terminal 130 (Step 142). The query response indicates whether a duplicate item is being purchased and/or whether an incompatibility exists. The retailer may then alert the purchasing user and provide an opportunity to alter her/his purchase decision.

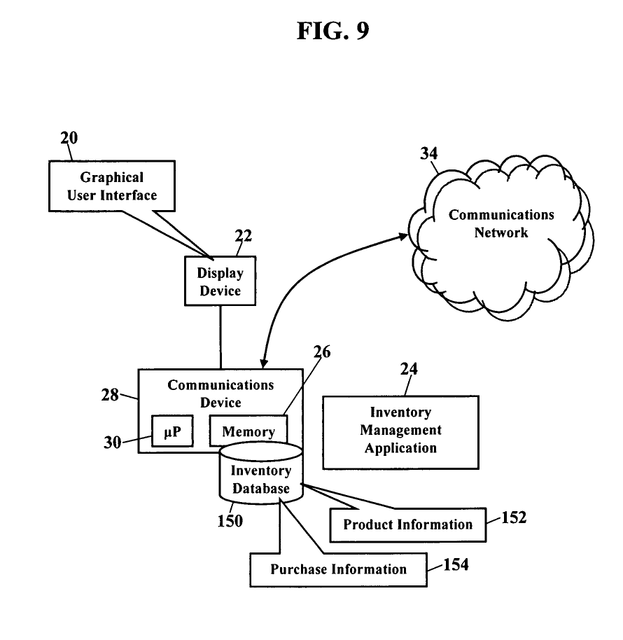

FIG. 9 is a schematic illustrating an inventory database 150, according to still more exemplary embodiments. Because the inventory management application 24 tracks and maintains a complete inventory of the user's personal property, real property, and/or possessions, the inventory management application 24 may store that inventory information in the inventory database 150. Anything the user purchases, owns, and/or possesses is stored in the inventory database 150. The inventory database 150, however, may also store more detailed information for each article. The inventory database 150, for example, may store product information 152 associated with each inventoried article. The product information 152 may include compete design, manufacturing, or operating specifications for each article, including the manufacturer's name, the date of manufacture, and even manufacturing codes (such as plant codes and date codes). The product information 152 may also include a complete manufacturing history of an inventoried article from origin to final sale. The product information 152, for example, may describe the receipt of raw materials and the vendor's name. The product information 152 may describe the dates, times, and locations of any molding/machining/fabricating operations for any components. The product information 152 may describe the date, time, and location of final assembly. The product information 152 may describe the date of shipment, the shipment method, and the shipper's name and route. The inventory database 150 may also store purchase information 154 associated with each inventoried article. The purchase information 154 describes the date of purchase, the supplier's or retailer's name and/or location, and the purchase price. The inventory database 150 thus maintains a complete inventory and description of the user's personal property, real property, and/or possessions. The inventory database 150 may further maintain a complete history of the user's personal property, real property, and/or possessions.

The information in the inventory database 150 may be transferred to any computer-readable media. The information stored in the inventory database 150 may be downloaded or saved to any computer-readable media, such as a CD-ROM, DVD, tape, cassette, floppy disk, or memory card/stick. The information in the inventory database 150 may even be magnetically stored or encoded, such as on a credit-card sized media. All the user's inventoried articles and purchases, for example, may be stored on a flexible card for easy storage in a wallet or purse. Whenever the user wishes to access their inventory, the user need only read or “swipe” the card in a reader. The card's magnetic stripe contains all the information in the inventory database 150. Because the user's inventory is stored on this credit card-sized media, this media is especially suitable to the existing capabilities of many retailers. The information in the inventory database 150, however, is savable to any storage media that suits the needs and desires of the user and/or retailer.

The information in the inventory database 150 may be easily updated. As the user makes purchases, the user may not want to manually enter those purchases into the inventory database 150. Manually typing each purchase, for example, would be laborious and inefficient. The inventory database 150, however, is easily updated using the computer-readable media. If the user transfers the information in the inventory database 150 to any computer-readable media, each retailer may update the inventory database 150. When the user purchases some good or service, the user presents the computer-readable media to the retailer. The user, for example, presents the magnetically-encoded, credit-card sized media to the retailer's point-of-sale terminal. The retailer's sales associate “swipes” the card and, thus, automatically updates the inventory database 150 with the article information 44 describing each purchased article. This magnetically-encoded, credit-card sized media may thus be referred to as a “purchasing memory card” that automatically records and updates the user's inventory database 150. The user is thus relieved from manually entering each purchase in the inventory database 150.

The inventory database 150 may even be associated with credit card account numbers. As the above paragraph explained, the user's inventory database 150 may be downloaded or saved to any computer-readable media, such as the magnetically-encoded, credit-card sized media. When the user presents the computer-readable media to the retailer's point-of-sale terminal, for example, the retailer's computer system automatically updates the inventory database 150 and conducts a transaction with a financial institution. That is, with a single “swipe” of a card, the user may charge or debit purchases and also update the user's inventory database 150. Financial institutions may even issue credit/debit cards that automatically link or interface with the user's inventory database 150. Whatever credit or debit card the user presents for purchases, the user's inventory database 150 is automatically updated with those purchases. The financial or banking institution's server associates the user's account information to a communications address of a computer or server storing the user's inventory database 150. As credit or debit transactions are processed, the financial or banking institution's server communicates with the inventory management application 24 and/or with the inventory database 150.

The inventory database 150 is also configurable. Each room in the building may be associated with a single person or with a group of persons. When the articles in that room are inventoried, each person or group associated with that room may uniquely configure that inventoried space. A person's bedroom items, for example may be configured “public” or “private” to limit what inventoried articles are accessible to other users. A person, in other words, may “hide” some articles in the inventory, thus preventing other people from accessing the entire inventory of that bedroom. The user may even set permissions, thus identifying those people who may access the inventory of that bedroom. When articles are configured or tagged as “public,” the user may even permit public access to those inventoried items. The inventoried items marked “public,” for example, may be accessible to third parties, such as friends, family, and even merchants. HOME DEPOT®, for example, may communicate with the inventory management application 24 and/or with the inventory database 150 to access the “public” inventory items. HOME DEPOT® may compare those “public” items to a database storing their goods and services. HOME DEPOT® may thus make product or service suggestions that, based on the “public” items, would appeal to the user.

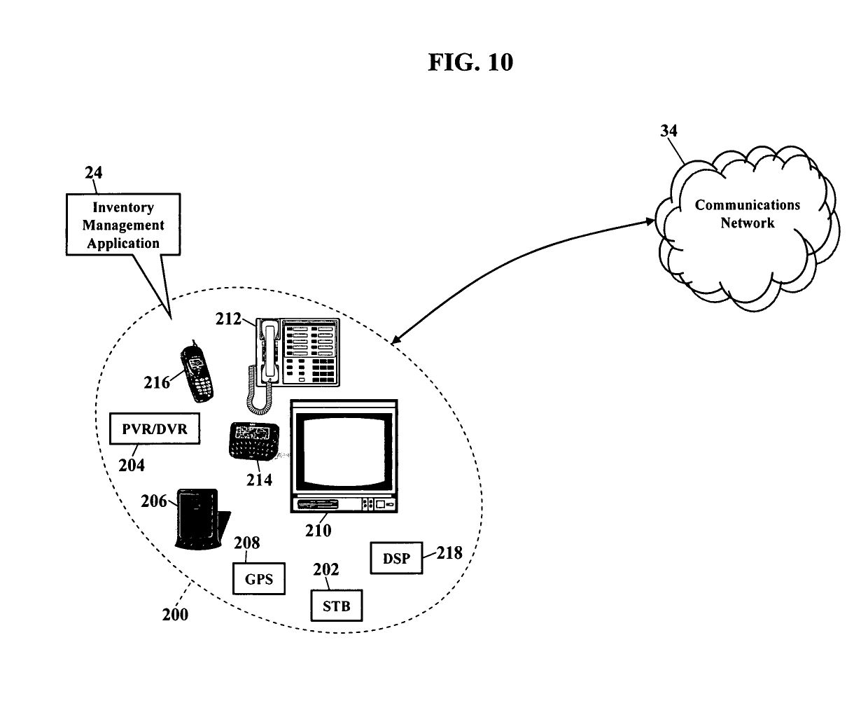

FIG. 10 depicts other possible operating environments for additional aspects of the exemplary embodiments. FIG. 10 illustrates that the inventory management application 24 may alternatively or additionally operate within various other communications devices 200. FIG. 10, for example, illustrates that the inventory management application 24 may entirely or partially operate within a set-top box (202), a personal/digital video recorder (PVR/DVR) 204, personal digital assistant (PDA) 206, a Global Positioning System (GPS) device 208, an interactive television 210, an Internet Protocol (IP) phone 212, a pager 214, a cellular/satellite phone 216, or any computer system and/or communications device utilizing a digital signal processor (DSP) 218. The communications device 200 may also include a personal gateway device, watches, radios, vehicle electronics, clocks, printers, gateways, and other apparatuses and systems. Because the architecture and operating principles of the various communications devices 200 are well known, the hardware and software componentry of the various communications devices 200 are not further shown and described. If, however, the reader desires more details, the reader is invited to consult the following sources, all incorporated herein by reference in their entirety: LAWRENCE HARTE et al., GSM SUPERPHONES (1999); SIEGMUND REDL et al., GSM AND PERSONAL COMMUNICATIONS HANDBOOK (1998); and JOACHIM TISAL, GSM CELLULAR RADIO TELEPHONY (1997); the GSM Standard 2.17, formally known Subscriber Identity Modules, Functional Characteristics (GSM 02.17 V3.2.0 (1995 January))”; the GSM Standard 11.11, formally known as Specification of the Subscriber Identity Module—Mobile Equipment (Subscriber Identity Module—ME) interface (GSM 11.11 V5.3.0 (1996 July))”; MICHEAL ROBIN & MICHEL POULIN, DIGITAL TELEVISION FUNDAMENTALS (2000); JERRY WHITAKER AND BLAIR BENSON, VIDEO AND TELEVISION ENGINEERING (2003); JERRY WHITAKER, DTV HANDBOOK (2001); JERRY WHITAKER, DTV: THE REVOLUTION IN ELECTRONIC IMAGING (1998); and EDWARD M. SCHWALB, ITV HANDBOOK: TECHNOLOGIES AND STANDARDS (2004).

The inventory management application 24 may be physically embodied on or in a computer-readable media or medium. This computer-readable media/medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the exemplary embodiments, allow the exemplary embodiments to be easily disseminated. A computer program product comprises the inventory management application 24 stored on the computer-readable media or medium. The inventory management application 24 comprises computer-readable instructions/code for managing inventory, as hereinabove explained. The inventory management application 24 may also be physically embodied on or in any addressable (e.g., HTTP, I.E.E.E. 802.11, Wireless Application Protocol (WAP), or BLUETOOTH®) wireless device capable of presenting an IP address.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method of managing inventory, comprising:
accessing a layout of a building describing a number of rooms in the building and a description of each of the rooms;
receiving article information describing an article to be inventoried;
associating the article information to a room descriptor that describes a room in the building; and
storing the article information in memory.

2. A method according to claim 1, further comprising accessing an occupancy of the building.

3. A method according to claim 1, further comprising:
receiving communications information describing communications requirements of the article to be inventoried;
accessing communications outlet information describing a communications outlet installed within one of the rooms of the building; and
associating the article information and the communications information to the communications outlet information.

4. A method according to claim 1, further comprising:
accessing communications equipment information describing communications equipment operating in at least one of the rooms of the building; and
associating the article information to the communications equipment information.

5. A method according to claim 1, further comprising:
receiving electrical information describing electrical requirements of the article to be inventoried;
accessing electrical outlet information describing an electrical outlet installed within at least one of the rooms of the building; and
associating the article information and the electrical information to the electrical outlet information.

6. A method according to claim 5, further comprising:
comparing the electrical information to the electrical outlet information; and
when the electrical information is incompatible with the electrical outlet information, then producing a prompt that notifies of the incompatibility.

7. A method according to claim 1, further comprising:
accessing construction material information describing a construction material used in at lest one of the rooms of the building; and
associating the article information to the construction material information.

8. A system of managing inventory, comprising:
an inventory management application stored in memory; and
a processor communicating with the memory and executing the inventory management application,
the inventory management application instructing the processor to access a residential layout of a building describing a number of rooms in the building and a description of each of the rooms, to receive article information describing an article to be inventoried, to associate the article information to a room descriptor that describes a room in the building, and to store the article information in the memory.

9. A system according to claim 8, the inventory management application further instructing the processor to access an occupancy of the building.

10. A system according to claim 8, the inventory management application further instructing the processor to:
receive communications information describing communications requirements of the article to be inventoried;
access communications outlet information describing a communications outlet installed within one of the rooms of the building; and
associate the article information and the communications information to the communications outlet information.

11. A system according to claim 8, the inventory management application further instructing the processor to:
access communications equipment information describing communications equipment operating in at least one of the rooms of the building; and
associate the article information to the communications equipment information.

12. A system according to claim 8, the inventory management application further instructing the processor to:
receive electrical information describing electrical requirements of the article to be inventoried;
access electrical outlet information describing an electrical outlet installed within one of the rooms of the building; and
associate the article information and the electrical information to the electrical outlet information.

13. A system according to claim 12, the inventory management application further instructing the processor to:
compare the electrical information to the electrical outlet information; and
when the electrical information is incompatible with the electrical outlet information, then produce a prompt that notifies of the incompatibility.

14. A system according to claim 8, the inventory management application further instructing the processor to:
access construction material information describing a construction material used in at least one of the rooms of the building; and
associate the article information to the construction material information.

15. A computer program product comprising computer-readable instructions for performing the steps:
accessing a layout of a building describing a number of rooms in the building and a description of each of the rooms;
receiving article information describing an article to be inventoried;
associating the article information to a room descriptor that describes a room in the building; and
storing the article information in memory.

16. A computer program product according to claim 15, further comprising instructions for accessing an occupancy of the building.

17. A computer program product according to claim 15, further comprising instructions for:
receiving communications information describing communications requirements of the article to be inventoried;
accessing communications outlet information describing a communications outlet installed within one of the rooms of the building; and
associating the article information and the communications information to the communications outlet information.

18. A computer program product according to claim 15, further comprising instructions for:
accessing communications equipment information describing communications equipment operating in at least one of the rooms of the building; and
associating the article information to the communications equipment information.

19. A computer program product according to claim 15, further comprising instructions for:
receiving electrical information describing electrical requirements of the article to be inventoried;
accessing electrical outlet information describing an electrical outlet installed within one of the rooms of the building; and
associating the article information and the electrical information to the electrical outlet information.

20. A computer program product according to claim 19, further comprising instructions for:
comparing the electrical information to the electrical outlet information; and
when the electrical information is incompatible with the electrical outlet information, then producing a prompt that notifies of the incompatibility.
